(19) United States
(12) Patent Application Publication
(10) Pub. No.: US 2026/0121009 A1
(43) Pub. Date: Apr. 30, 2026

(54) CHARGED PARTICLE BEAM FOCUSING DEVICE

(71) Applicant: Samsung Electronics Co., Ltd., Suwon-si (KR)

(72) Inventors: Jongmin YOON, Suwon-si (KR); Taesung KIM, Suwon-si (KR); Seungjae LEE, Suwon-si (KR)

(73) Assignees: Samsung Electronics Co., Ltd., Suwon-si (KR); RESEARCH & BUSINESS FOUNDATION SUNGKYUNKWAN UNIVERSITY, Gyeonggi-do (KR)

(21) Appl. No.: 19/193,426

(22) Filed: Apr. 29, 2025

(30) Foreign Application Priority Data
Oct. 24, 2024 (KR) 10-2024-0146575

(51) Int. Cl. H01J 49/06

(52) U.S. Cl. CPC H01J 49/066; H01J 49/068

(57) ABSTRACT

Some example embodiments relate to a charged particle beam focusing device including a charged particle funnel configured to move charged particles. The charged particle funnel comprises an electrode part including a plurality of electrode parts stacked in a first direction, a charged particle inlet portion in an electrode part at a foremost end among the plurality of electrode parts, the charged particle inlet portion configured to introduce the charged particles, a charged particle outlet portion in an electrode part at a rearmost end among the plurality of electrode parts the charged particle outlet portion configured to discharge the charged particles, and a charged particle guide portion extending from the charged particle inlet portion to the charged particle outlet portion and configured to move the charged particles. The plurality of electrode parts each comprises a plurality of electrodes arranged on a plane in a second direction.

### CROSS-REFERENCE TO RELATED APPLICATION

This application claims priority to and the benefit of Korean Patent Application No. 10-2024-0146575 filed in the Korean Intellectual Property Office on Oct. 24, 2024, the entire contents of which are incorporated herein by reference.

### BACKGROUND

Example embodiments of the present disclosure relate to a device for identifying uniformity of a process, and more particularly, to a charged particle beam focusing device.

Uniformity, efficiency, and/or other parameters of semiconductor processes may be detected by analyzing by-products, such as charged particles, produced during a semiconductor process. A charged particle beam focusing device may be utilized as a device for identifying the uniformity, efficiency, and/or other parameters of the process. The charged particle beam focusing device may be a device disposed at a front end of a mass spectrometer that may focus and deliver charged particles contained in by-products from a low-vacuum process region to a high-vacuum mass spectrometry region.

The charged particle beam focusing device may focus and deliver charged particle by-products, which are produced during semiconductor processes, from the low-vacuum region to the high-vacuum region, and the mass spectrometer may monitor various parameters of the process by analyzing the focused charged particles.

The charged particle beam focusing device may extract some process by-products, such as gas molecules or particulates produced during a semiconductor process, such as chemical vapor deposition (CVD) or etching, from a vacuum chamber. Thereafter, the charged particles, which are already charged or charged by plasma, electron collisions, or light, are inputted to the charged particle beam focusing device.

The charged particle beam focusing device focuses the charged particles by using an electric field or a magnetic field and transporting the charged particles to an analysis device such as the mass spectrometer. Thereafter, the focused charged particles are analyzed by methods such as residual gas analysis (RGA) or time-of-flight mass spectrometry. Therefore, it may be possible to analyze the composition of the by-products produced by the semiconductor process.

As described above, it may be possible to identify whether the composition of the by-product, which is produced during the process, is constant over time or positions by analyzing the composition of the charged particles contained in the by-products produced by the semiconductor process. Therefore, it may be possible to monitor, in real time, whether the semiconductor process is properly performed. Furthermore, the uniformity, efficiency, tool matching, and/or other parameters of semiconductor processes may be improved, thereby improving the reliability and/or electrical properties of a semiconductor device.

In comparative examples where the charged particle beam focusing device utilizes an ion funnel for electrically focusing the charged particles, or an aerodynamic lens. The ion funnel may form an electric field on an electrode and assist in allowing the charged particles to be concentrated by the funnel and moved to a focal point region of the mass spectrometer. The aerodynamic lens may change kinetic energy of the particles by accelerating an airflow by means of multiple nozzles and assist in allowing the charged particles to be collected in a single line and moved to the focal point region of the mass spectrometer.

However, the above-mentioned examples for a charged particle beam focusing device cannot easily focus the charged particles under high-vacuum process pressure conditions equal to or lower than several or several tens of m Torr. Specifically, there is a problem in that the ion funnel cannot focus the charged particles when the pressure is low. More specifically, in cases where the pressure is excessively low in the low-vacuum region, the charged particles may not be easily focused because of a depth of a potential well that decreases from an inlet part to an outlet part of the ion funnel.

In cases relating to comparative examples of the aerodynamic lens, the charged particles may move in the molecular or transition regime under a high-vacuum pressure condition and move freely without following flow characteristics before and after a multi-stage orifice in the lens, which may cause problems in that the charged particles may not be focused.

### SUMMARY

Some example embodiments of the present disclosure provide a charged particle beam focusing device with improved characteristics in focusing charged particles under a high-vacuum pressure conditions during a semiconductor process.

Some example embodiments of the present disclosure provide a charged particle beam focusing device including a charged particle funnel configured to move charged particles. The charged particle funnel comprises an electrode part including a plurality of electrode parts stacked in a first direction, a charged particle inlet portion in an electrode part at a foremost end among the plurality of electrode parts, the charged particle inlet portion configured to introduce the charged particles, a charged particle outlet portion in an electrode part at a rearmost end among the plurality of electrode parts the charged particle outlet portion configured to discharge the charged particles, and a charged particle guide portion extending from the charged particle inlet portion to the charged particle outlet portion and configured to move the charged particles. The plurality of electrode parts each comprises a plurality of electrodes arranged on a plane in a second direction, the second direction being perpendicular to the first direction. The charged particle guide portion is a region in which inscribed circles between each of the plurality of electrodes on the plane extend from the charged particle inlet portion to the charged particle outlet portion. A radii of each of the inscribed circles decreases from the charged particle inlet portion toward the charged particle outlet portion.

Some example embodiments of the present disclosure provide a charged particle funnel configured to move charged particles. The charged particle funnel comprises an electrode part including a plurality of electrode parts stacked in a first direction, the plurality of electrode parts each comprises a plurality of electrodes arranged on a plane in a second direction, the second direction being perpendicular to the first direction, an alternating current power includes a (+) alternating current (AC) power or a (−) alternating current power alternately supplied to each pair of electrodes of the plurality of electrodes adjacent to one another. The alternating current power is variably supplied to the plurality of electrode parts.

Some example embodiments of the present disclosure provide a charged particle funnel configured to move charged particles. The charged particle funnel comprises an electrode part including a plurality of electrode parts stacked in a first direction and configured to be supplied with a variable power, a charged particle inlet portion in an electrode part at a foremost end among the plurality of electrode parts, and the charged particle inlet portion configured to introduce the charged particles, a charged particle outlet portion in an electrode part at a rearmost end among the plurality of electrode parts, the charged particle outlet portion configured to discharge the charged particles, and a charged particle guide portion extending from the charged particle inlet portion to the charged particle outlet portion and configured to move the charged particles, the plurality of electrode parts each comprises a plurality of electrodes arranged on a plane in a second direction, the second direction being perpendicular to the first direction. The charged particle guide portion is a region including inscribed circles between each of the plurality of electrodes on the plane extend from the charged particle inlet portion to the charged particle outlet portion, and a radii of each of the inscribed circles, thicknesses of the plurality of electrode parts, and intervals between the plurality of electrode parts decrease in one direction.

According to the charged particle beam focusing device according to some example embodiments of the present disclosure, the radii of the inscribed circles formed by the electrode parts including multiple poles may decrease from the charged particle inlet portion toward the charged particle outlet portion, such that the depth of the potential well for trapping the charged particles does not decrease, which may improve the efficiency in focusing the charged particles under high-vacuum pressure conditions.

According to another example embodiment of the present disclosure, the charged particle beam focusing device may variably control the alternating current power and the direct current power to the electrode parts, which may achieve the same efficiency in focusing the charged particles with various masses and charge amount ranges under high-vacuum pressure conditions.

Some example embodiments of the present disclosure provide a method of operating a charged particle beam focusing device, the method including performing a semiconductor manufacturing process in a semiconductor manufacturing apparatus, introducing charged particles into the charged particle beam focusing device, focusing and guiding the charged particles using an electrode part of the charged particle beam focusing device to a mass spectrometry device, and analyzing the focused charged particles by the mass spectrometry device using a mass spectrometry analysis method. The semiconductor manufacturing process is performed in a low-vacuum state. The charged particles are a portion of by-products generated by the semiconductor manufacturing process. The charged particle beam focusing device includes a charged particle funnel configured to move the charged particles. The charged particle funnel comprises the electrode part including a plurality of electrode parts stacked in a first direction, the plurality of electrode parts each comprises a plurality of electrodes arranged on a plane in a second direction, the second direction being perpendicular to the first direction, an alternating current power includes a (+) alternating current (AC) power or a (−) alternating current power alternately supplied to each pair of electrodes of the plurality of electrodes adjacent to one another, and the alternating current power is variably supplied to the plurality of electrode parts.

According to some example embodiments of the present disclosure the mass spectrometry analysis method is at least one selected from a group comprising residual gas analysis (RGA) and time-of-flight mass spectrometry.

### BRIEF DESCRIPTION OF THE DRAWINGS

FIG. 1 is a schematic view of a semiconductor process according to some example embodiments of the present disclosure.

FIG. 2 is an enlarged view of region A in FIG. 1, e.g., an enlarged view of a charged particle beam focusing device, and FIG. 3 is a perspective view of the charged particle beam focusing device according to some example embodiments of the present disclosure.

FIGS. 4 and 5 are cross-sectional views of the charged particle beam focusing device according to some example embodiments of the present disclosure.

FIGS. 6 and 7 are views illustrating an electrode part according to some example embodiments of the present disclosure.

FIGS. 8 and 9 are cross-sectional views of the electrode part according to some example embodiments of the present disclosure.

FIGS. 10 and 11 are a perspective view and a cross-sectional view of region B in FIG. 2.

FIG. 12 is a cross-sectional view of a charged particle size sorting device including the charged particle beam focusing device according to some example embodiments of the present disclosure, and FIG. 13 is a perspective view of the charged particle size sorting device including the charged particle beam focusing device.

FIG. 14 is a schematic view for explaining the formation of a potential well according to some example embodiments of the present disclosure.

FIG. 15 is a potential well graph related to region C in FIG. 14.

FIGS. 16 to 18 are graphs showing results of evaluating a charged particle focusing output of the charged particle beam focusing device according to some example embodiments of the present disclosure.

FIGS. 19 to 22 are views illustrating results of evaluating spatial efficiency of the charged particle beam focusing device according to some example embodiments of the present disclosure.

FIGS. 23 to 25 are graphs showing results of evaluating charged particle passage efficiency of the charged particle size sorting device including the charged particle beam focusing device in FIGS. 12 and 13.

FIGS. 26 to 30 are views illustrating results of evaluating spatial efficiency of the charged particle size sorting device including the charged particle beam focusing device in FIGS. 12 and 13.

### DETAILED DESCRIPTION

Hereinafter, several example embodiments of the present disclosure will be described in detail with reference to the accompanying drawings so that those skilled in the technical field to which the present disclosure pertains may easily carry out the example embodiments. The present disclosure may be implemented in various different ways and is not limited to the example embodiments described herein.

A part irrelevant to the description will be omitted to clearly describe the example embodiments of the present disclosure, and the same or similar constituent elements will be designated by the same reference numerals throughout the specification.

In addition, a size and thickness of each constituent element illustrated in the drawings are arbitrarily shown for convenience of description, but the present disclosure is not limited thereto. In order to clearly describe several layers and regions, thicknesses thereof are enlarged in the drawings. In the drawings, the thicknesses of some layers and regions are exaggerated for convenience of description.

In addition, when one component such as a layer, a film, a region, or a plate is described as being positioned “above” or “on” another component, one component can be positioned “directly on” another component, and one component can also be positioned on another component with other components interposed therebetween. On the contrary, when one component is described as being positioned “directly above” another component, there is no component therebetween. In addition, when a component is described as being positioned “above” or “on” a reference part, the component may be positioned “above” or “below” the reference part, and this configuration does not necessarily mean that the component is positioned “above” or “on” the reference part in a direction opposite to gravity.

Throughout the specification, unless explicitly described to the contrary, the term “comprise/include” and variations such as “comprises/includes” or “comprising/including” will be understood to imply the inclusion of stated elements, not the exclusion of any other elements.

In addition, throughout the specification, the term “in a plan view” means when an object is viewed from above, and the term “in a cross-sectional view” means when a cross section made by vertically cutting an object is viewed from a lateral side.

Hereinafter, some example embodiments of the present disclosure will be described in detail so that those skilled in the technical field to which the present disclosure pertains may easily carry out the example embodiments. However, the present disclosure may be implemented in various different ways and is not limited to the example embodiments described herein.

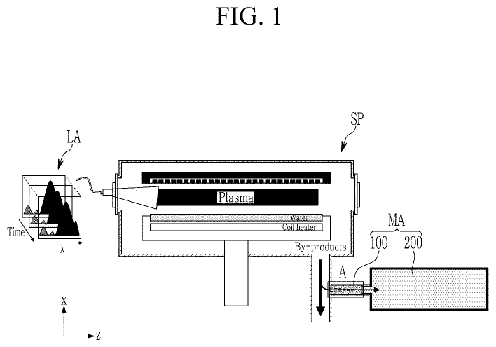

FIG. 1 is a schematic view of a semiconductor process according to some example embodiments of the present disclosure.

With reference to FIG. 1, a semiconductor process SP such as chemical vapor deposition (CVD) or etching performs a process of forming a solid thin film on a wafer by using an energy source, such as plasma, or a process of removing a part of a thin film. Charged particles, such as by-products remaining during the semiconductor process SP, may be discharged in a gas phase.

As a technology for monitoring whether the process is appropriately performed in the semiconductor process SP, monitoring technologies, such as a light-based analysis process (LA) and a mass spectrometry-based analysis process MA, may be utilized. As a non-restrictive example of the light-based analysis process (LA), monitoring technologies, such as optical emission spectroscopy (OES) or laser interferometry, may be utilized. As the mass spectrometry-based analysis process MA, a residual gas analyzer (RGA), a particle beam mass spectrometer (PBMS), quadrupole mass spectrometer (QMS), or magnetic sector mass spectrometer may be utilized.

Among the above-mentioned monitoring technologies, the mass spectrometry-based analysis process MA extracts and samples some of the charged particles when the charged particles produced during the process are discharged through an exhaust line, and then the device, such as the mass spectrometer, performs the mass spectrometry on the charged particles, thereby monitoring whether the semiconductor process SP is appropriately performed. In this case, in order to extract some of the charged particles and input some of the charged particles into the mass spectrometer, there is a problem in that differential pressure is formed between pressure in the semiconductor process SP and operating pressure in the mass spectrometry-based analysis process MA. Specifically, the pressure of the semiconductor process SP is equal to or higher than several or several tens of m Torr, and the operating pressure of the mass spectrometry-based analysis process MA is low pressure of 10⁻⁵ Torr or less, such that the differential pressure may need to be formed.

The mass spectrometry-based analysis process MA may require a charged particle beam focusing device 100 configured to focus charged particles, and a mass spectrometry device 200 configured to analyze mass of the focused charged particles. The charged particle beam focusing device 100 may be a device configured to focus the charged particles in the region of the semiconductor process SP in a low-vacuum state and deliver the charged particles to the mass spectrometry device 200 in a high-vacuum state. The mass spectrometry device 200 may analyze the mass of the focused charged particles in the region of the semiconductor process SP and identify whether the semiconductor process SP is kept in a targeted process state.

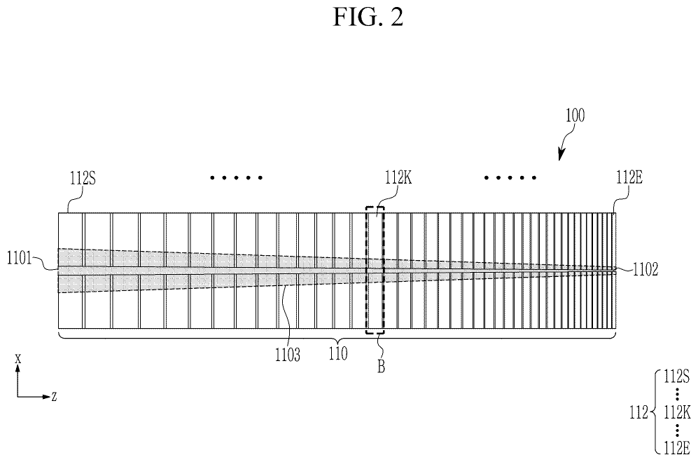

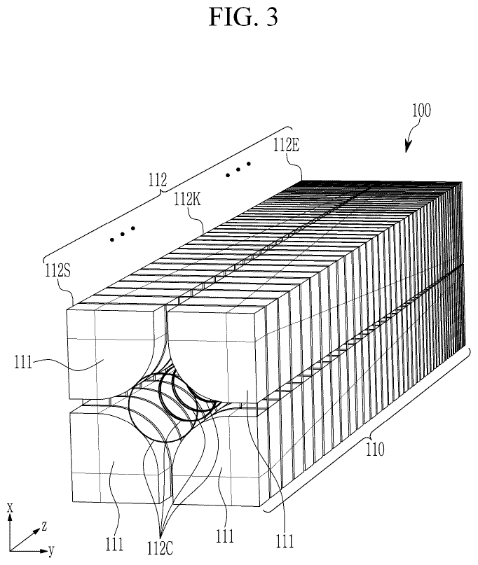

FIG. 2 is an enlarged view of region A in FIG. 1, e.g., an enlarged view of the charged particle beam focusing device 100, and FIG. 3 is a perspective view of the charged particle beam focusing device 100 according to some example embodiments of the present disclosure.

With reference to FIGS. 2 and 3, the charged particle beam focusing device 100, which focuses the charged particles into the mass spectrometry device, may include a charged particle funnel 110 including a plurality of electrode parts 112 including electrodes 111 with multi-pole structures. The multi-pole structure may be a structure having several polarities and configured to precisely control motions of the charged particles by using electrodes or magnets disposed symmetrically.

In some example embodiments, the charged particle funnel 110 may include the plurality of electrode parts 112 stacked in one direction. Specifically, the electrode part 112 may include a plurality of electrodes 111 arranged on a plane perpendicular to one direction.

The electrode 111 may be disposed on the plane defined by a first direction (X-axis) and a second direction (Y-axis) arranged on the plane perpendicular to one direction. The plurality of electrode parts 112 may be stacked and disposed in a third direction (Z-axis) that is one direction.

The electrode 111 may have a multi-pole structure. Specifically, the electrode 111 is not a single electrode, but the plurality of electrodes may be disposed on an X-Y plane defined by the X-axis, e.g., the first direction and the Y-axis, e.g., the second direction. More specifically, the electrodes 111 may be disposed on the X-Y plane and spaced apart from one another, thereby reducing (and/or minimizing) interference caused by a supply of power.

In the multi-pole structure, the plurality of electrodes may be disposed to be spaced apart from one another and focus the charged particles. Specifically, the multi-pole structure may form an electric field or a magnetic field so that the charged particles move along a central axis that passes through centers of the plurality of electrode parts 112 in the third direction (Z-axis). The charged particle beam focusing device may adjust trajectories of the charged particles in the first direction and the second direction so that the charged particles are more efficiently collected on the central axis. As described above, the multi-pole structure applies power to the electrode 111, such that field regions formed by (+) power and (−) power are canceled in the intermediate region when a potential well for trapping the charged particles is formed in the electrode part 112 including the plurality of electrodes 111. Therefore, it Is possible to solve the problem in which a depth of the potential well of the ion funnel in the comparative examples decreases from a foremost end electrode part to a rearmost end electrode part and the charged particles cannot be focused.

The plurality of electrode parts 112 each refers to an electrode part including the electrode 111 with the multi-pole structure. The electrode parts 112 are stacked in the third direction. Specifically, the electrode part 112 may include an electrode part 112S disposed at a foremost end, an electrode part 112E disposed at a rearmost end, and a k-th electrode part 112K disposed between the electrode part 112S disposed at the foremost end and the electrode part 112E disposed at the rearmost end.

The k-th electrode part 112K (where k is an integer referring to the numerical order of the electrode parts) refers to a k-th electrode part among the electrode parts 112 including the electrode part 112S disposed at the foremost end and the electrode part 112E disposed at the rearmost end. For example, the electrode part, which is disposed after the electrode part 112S disposed at the foremost end from the k-th electrode part 112K may be named a first electrode part, and the electrode part disposed after the first electrode part may be named a second electrode part.

In some example embodiments, five or more electrode parts 112 may be disposed adjacent to one another. Specifically, the plurality of electrode parts 112, e.g., the five or more electrode parts 112 may be disposed, and the electrode parts 112 may be disposed to be spaced apart from one another at desired (and/or alternatively predetermined) intervals. For example, in a case where the number of electrode parts 112 is five, the electrode parts 112 may include the electrode part 112S disposed at the foremost end, the electrode part 112E disposed at the rearmost end, and eight electrode parts 112 disposed between the electrode part 112S disposed at the foremost end and the electrode part 112E disposed at the rearmost end.

As described above, when the number of electrode parts 112 is five or more, the efficiency in focusing the charged particles may be improved. In a case where the number of electrode parts 112 is smaller than the above-mentioned number, the charged particles are discharged to the outside during the focusing process, which may cause a problem in that the focusing efficiency may deteriorate.

In some example embodiments, thicknesses of the plurality of electrode parts 112 may decrease in the third direction (Z-axis). The thickness of each of the plurality of electrode parts 112 may refer to a length of the electrode part 112 in the third direction. Specifically, the plurality of electrode parts 112 may be disposed such that the thicknesses of the electrode parts decrease at desired (and/or alternatively predetermined) ratios from the electrode part 112S disposed at the foremost end toward the electrode part 112E disposed at the rearmost end. For example, the thickness of the electrode part 112S disposed at the foremost end may be larger than a thickness of a first electrode part 112 disposed adjacent to the electrode part 112S disposed at the foremost end, and the thickness of the first electrode part 112 may be larger than a thickness of a second electrode part 112 disposed adjacent to the first electrode part 112.

In some example embodiments, the plurality of electrode parts 112 may be disposed to be spaced apart from one another at desired (and/or alternatively predetermined) intervals. Specifically, the desired (and/or alternatively predetermined) intervals between the plurality of electrode parts 112 may decrease at desired (and/or alternatively predetermined) ratios from the electrode part 112S disposed at the foremost end toward the electrode part 112E disposed at the rearmost end. For example, an interval between the electrode part 112S disposed at the foremost end and the first electrode part 112 disposed adjacent to the electrode part 112S may be larger than an interval between the first electrode part 112 and the second electrode part 112.

As described above, the thicknesses of the electrode parts 112 and the intervals between the electrode parts 112 decrease in the third direction (Z-axis), such that the charged particles may be easily seated in the potential wells formed in the electrode parts, which may reduce and/or prevent the charged particles from separating through the intervals between the electrode parts 112.

In some example embodiments, the charged particle funnel 110 may include a charged particle inlet portion 1101, a charged particle outlet portion 1102, and a charged particle guide portion 1103. Specifically, the charged particle funnel 110 may focus the charged particles, which are produced during the semiconductor process, into the mass spectrometry device through potential well guides for the charged particles formed by the plurality of electrode parts 112 including the electrodes 111.

The charged particle inlet portion 1101 may introduce the charged particles, which are disposed in the semiconductor process region, into the charged particle beam focusing device 100. Specifically, the charged particle inlet portion 1101 may be positioned at the position on the electrode part 112S disposed at the foremost end among the plurality of electrode parts 112 and introduce the charged particles. The charged particles having passed through the charged particle inlet portion 1101 may be discharged through the charged particle outlet portion 1102 and move to the mass spectrometry device.

The charged particle outlet portion 1102 may discharge the charged particles, which are introduced through the charged particle inlet portion 1101, to the mass spectrometry device. Specifically, the charged particle outlet portion 1102 may be positioned at the position on the electrode part 112E disposed at the rearmost end among the plurality of electrode parts 112 and discharge the charged particles. As described above, the charged particles discharged through the charged particle outlet portion 1102 may move to the mass spectrometry device, and the mass spectrometry device may monitor the semiconductor process SP.

The charged particle guide portion 1103 refers to a region in which the charged particles move from the charged particle inlet portion 1101 to the charged particle outlet portion 1102. Specifically, the charged particle guide portion 1103 may serve as a guide configured to guide the charged particles so that the charged particles may be easily focused into the mass spectrometry device.

In some example embodiments, the charged particle guide portion 1103 may be formed by inscribed circles 112C of the multi-pole structure of the electrode 111. Specifically, the charged particle guide portion 1103 may be formed by the inscribed circles 112C formed by the electrodes 111 of the multi-pole structure based on the central axis of the electrode part 112. FIGS. 2 and 3 illustrate the inscribed circle 112C on the X-Y plane defined in the first direction (X-axis) and the second direction (Y-axis). However, the inscribed circle may refer to a cylindrical shape formed by the plurality of electrodes 111 in the electrode part 112.

In some example embodiments, radii of the inscribed circles 112C may decrease from the charged particle inlet portion 1101 toward the charged particle outlet portion 1102. Specifically, radii of the inscribed circles 112C formed by the electrodes 111 may decrease from the electrode part 112S disposed at the foremost end toward the electrode part 112E disposed at the rearmost end. Because the radii of the inscribed circles 112C decrease in the third direction (Z-axis) as described above, the charged particles are moved to the inner regions of the inscribed circles and focused.

In some example embodiments, the radii of the inscribed circles 112C may gradually decrease at desired (and/or alternatively predetermined) ratios with respect to the plurality of electrode parts 112. Specifically, the radii of the inscribed circles 112C may decrease in the third direction, and the thicknesses of the electrode parts 112 may decrease in a geometrical series. More specifically, because the radii of the inscribed circles 112C decrease at desired (and/or alternatively predetermined) ratios in the third direction, the charged particles may be easily trapped in the charged particle guide portion 1103, such that the charged particles may be easily focused into the mass spectrometry device.

In some example embodiments, the plurality of electrodes 111 may each have a shape formed convexly in the direction of the central portion of the electrode part 112. Specifically, the inner surfaces of the plurality of electrodes 111 may be convexly formed. Because the inner surface of the electrode 111 is formed convexly in the direction of the central portion of the electrode part 112, the inscribed circle 112C may be easily formed, and the charged particle guide portion 1103 may be easily formed.

In some example embodiments, the charged particle guide portion 1103 may extend in a direction parallel to the third direction (Z-axis). Specifically, the charged particle guide portion 1103 may be formed in a direction parallel to the central axis of the electrode part 112. The charged particle guide portion 1103 is disposed in the direction parallel to the third direction (Z-axis), such that the charged particles may be moved in the corresponding direction and focused.

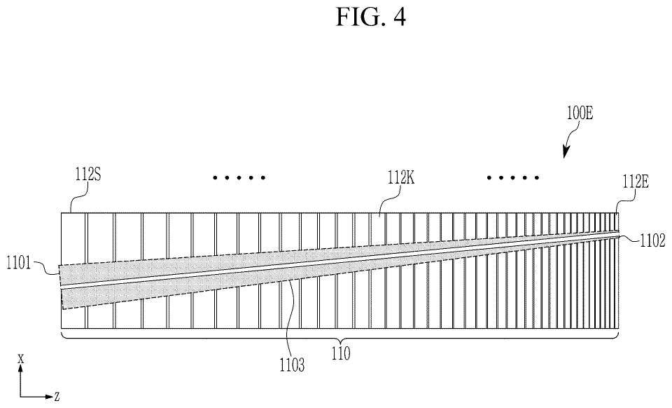

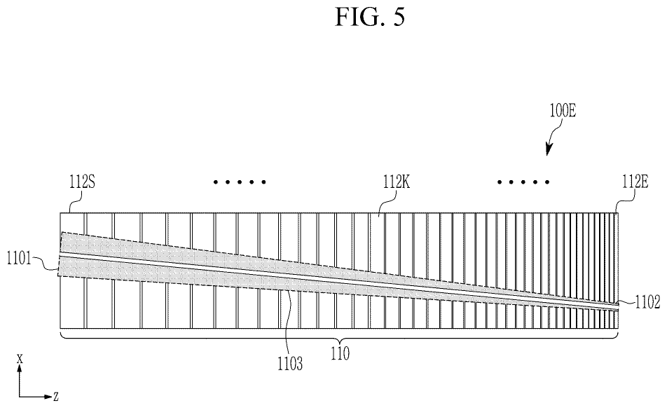

FIGS. 4 and 5 are cross-sectional views of the charged particle beam focusing device 100 according to some example embodiments of the present disclosure.

With reference to FIGS. 4 and 5, the charged particle guide portion 1103 may be disposed in a direction inconsistent with the third direction (Z-axis). Specifically, the charged particle guide portion 1103 may be formed in a diagonal direction in the third direction. More specifically, FIG. 4 illustrates that the charged particle guide portion 1103 may be formed in the diagonal direction from a lower region toward an upper region based on the central axis of the electrode part 112. The lower region and the upper region may be distinguished based on the central axis formed in the third direction (Z-axis) while connecting the centers of the electrode parts 112. FIG. 5 illustrates that the charged particle guide portion 1103 may be formed in the diagonal direction from the upper region toward the lower region based on the central axis of the electrode part 112. As described above, the charged particle guide portion 1103 may be disposed in various example embodiments, such that focusing directions and focusing positions of the charged particles may be changed.

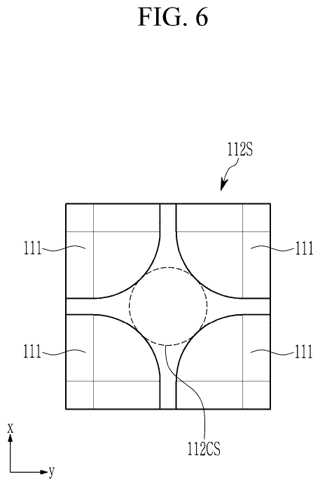

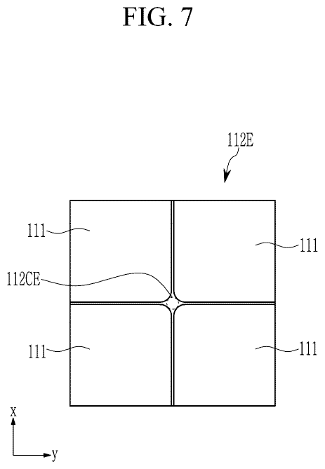

FIGS. 6 and 7 are views illustrating the electrode part 112 according to some example embodiments of the present disclosure.

FIGS. 6 and 7 are views illustrating the electrode part 112S disposed at the foremost end and the electrode part 112E disposed at the rearmost end when viewed from the front and rear sides. With reference to FIGS. 6 and 7, in some example embodiments, the inscribed circle 112CS formed by the electrode part 112S disposed at the foremost end may be larger than the inscribed circle 112CE formed by the electrode part 112E disposed at the rearmost end. As described above, a radius of the inscribed circle 112CS of the electrode part 112S disposed at the foremost end is larger than a radius of the inscribed circle 112CE of the electrode part 112E disposed at the rearmost end, such that the charged particles may be easily focused into the charged particle outlet portion 1102 from the charged particle inlet portion 1101.

In some example embodiments, the radius of the inscribed circle 112CS of the electrode part 112S disposed at the foremost end and the radius of the inscribed circle 112CE of the electrode part 112E disposed at the rearmost end may satisfy Expression 1 below.

$$3 \leq {R}_{out} / {R}_{in} \leq 15 \qquad < Expression 1 >$$

(In Expression 1, Rᵢₙ represents a radius of the inscribed circle of the electrode part disposed at the foremost end among the plurality of electrode parts, and Rₒᵤₜ represents a radius of the inscribed circle of the electrode part disposed at the rearmost end among the plurality of electrode parts.)

Expression 1 shows a ratio of the radius of the inscribed circle of the charged particle outlet portion 1102 to the radius of the inscribed circle of the charged particle inlet portion 1101. Expression 1 may be 3 to 15, and specifically Expression 1 may be 5 to 10. When Expression 1 satisfies the above-mentioned range, the charged particles may be easily focused.

In a case where Expression 1 deviates from an upper limit value within the above-mentioned range, a facility length of the charged particle beam focusing device 100 is excessively increased, which may make it difficult to make the charged particle beam focusing device 100 commercially available in order to implement the efficiency improvement in focusing the charged particles. In a case where Expression 1 deviates from a lower limit value within the above-mentioned range, the number of charged particles accommodated in the charged particle guide portion 1113 decreases, which causes a problem in that the charged particle detection sensitivity of the mass spectrometry device deteriorates.

In some example embodiments, a radius Rᵢₙ of the inscribed circle of the electrode part 112S disposed at the foremost end may be 5 to 15 mm, specifically, 6 to 12 mm. In some example embodiments, a radius Rₒᵤₜ of the inscribed circle of the electrode part 112E disposed at the rearmost end may be 0.5 to 1.5 mm. Specifically, the radius Rᵢₙ of the inscribed circle of the electrode part 112S disposed at the foremost end and the radius Rₒᵤₜ of the inscribed circle of the electrode part 112E disposed at the rearmost end may respectively refer to a radius of a first guide portion of the electrode part 112S disposed at the foremost end and a radius of the second guide portion of the electrode part disposed at the rearmost end. The specific numerical value of the radius of the above-mentioned inscribed circle is a non-restrictive example and may be easily adjusted depending on designs and modifications of facilities.

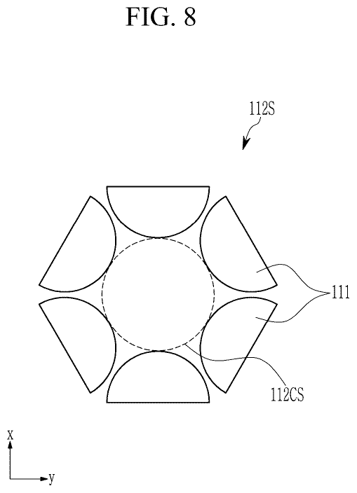

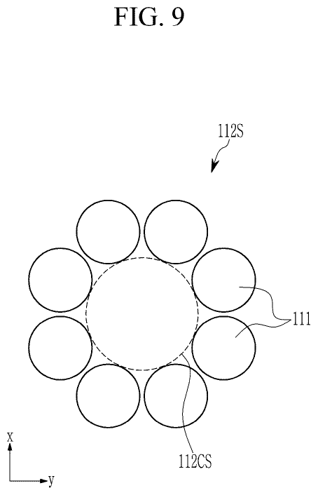

FIGS. 8 and 9 are cross-sectional views of the electrode part 112 according to some example embodiments of the present disclosure.

With reference to FIGS. 8 and 9, in some example embodiments, the electrodes 111 may have the multi-pole structure including at least two or more electrodes. Specifically, the multi-pole structure includes the plurality of electrodes. As described above, the plurality of electrodes 111 includes the multi-pole structures spaced apart from one another, such that interference between the electrodes 111 may be reduced (and/or minimized), and power may be separately supplied to the electrodes 111, thereby forming the potential well that traps the charged particles.

More specifically, there may be an even number of electrodes 111. Specifically, the electrode part 112 may include an even number of electrodes. The even number of electrodes 111 may be included in the electrode part 112 so that (+) power and (−) power may be supplied correspondingly.

A cross-sectional shape of the electrode 111 may be a semicircular shape, as illustrated in FIG. 8, or a circular shape, as illustrated in FIG. 9. The cross-sectional shape of the electrode 111 is a non-restrictive example and may include all various shapes capable of forming the inscribed circles by the electrodes 111.

In accordance with the cross-sectional shape of the electrode 111, the cross-sectional shape of the electrode part 112S disposed at the foremost end may also include various shapes. The cross-sectional shape of the electrode part 112S disposed at the foremost end is a non-restrictive example and may include all various embodiments in which the inscribed circle 112CS is easily formed by the electrode 111, and the electrodes 111 are disposed to be spaced apart from one another while reducing (and/or minimizing) interference.

FIGS. 8 and 9 illustrate the electrode part 112S disposed at the foremost end. However, the same may also apply to the electrode part 112E disposed at the rearmost end or the above-mentioned k-th electrode part 112K. Specifically, the electrode parts (112S, . . . , 112K, . . . , 112E) described above with reference to FIGS. 8 and 9 differ from one another only in terms of the radii of the inscribed circles formed by the electrodes 111, the thicknesses of the electrode parts, and the intervals between the electrode parts and are identical to one another within the range that does not contradict the above-mentioned contents.

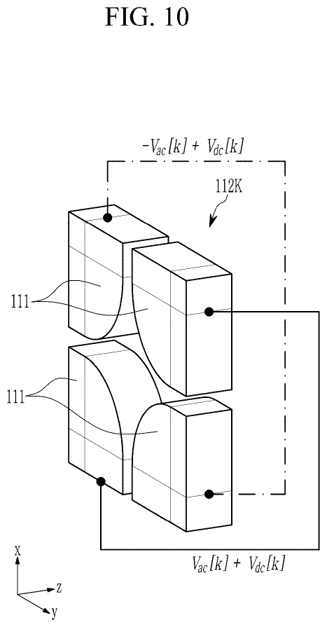

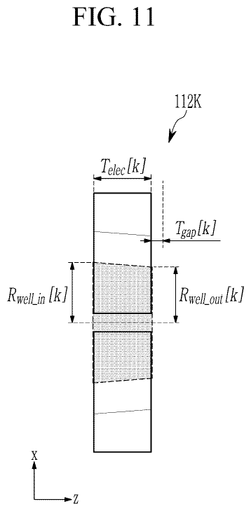

FIGS. 10 and 11 are a perspective view and a cross-sectional view of region B in FIG. 2.

FIGS. 10 and 11 are a perspective view and a cross-sectional view of the k-th electrode part 112K that is region B in FIG. 2. With reference back to FIG. 10, in some example embodiments, alternating current (AC) power may be supplied to the plurality of electrodes 111. The alternating current power is supplied to the electrode 111, such that the potential well in which the charged particles may be accommodated and moved may be formed.

In some example embodiments, the alternating current power may include (+) alternating current power (V_{ac}[k]) and (−) alternating current power (−V_{ac}[k]), and the (+) alternating current power (V_{ac}[k]) and the (−) alternating current power (−V_{ac}[k]) may be alternately supplied to the electrodes 111 disposed adjacent to one another. For example, when the (+) alternating current power (V_{ac}[k]) is supplied to one electrode 111, the (−) alternating current power (−V_{ac}[k]) may be supplied to the adjacent electrode 111. As described above, the (+) alternating current power (V_{ac}[k]) and the (−) alternating current power (−V_{ac}[k]) are alternately supplied to the plurality of electrodes 111 of the present disclosure, such that it is possible to reduce and/or prevent the problem in which the depth of the potential well formed by the (+) alternating current power (V_{ac}[k]) and the (−) alternating current power (−V_{ac}[k]) decreases from the electrode part at the foremost end toward the electrode part at the rearmost end, which may improve the efficiency in focusing the charged particles even under a high-vacuum pressure condition.

In some example embodiments, direct current (DC) power (V_{dc}[k]) may be supplied to the plurality of electrodes 111. Specifically, the same direct current power (V_{ac}[k]) may be supplied to the plurality of electrodes 111 in the k-th electrode part 112K. The direct current power (V_{ac}[k]) may form slopes of the potential wells formed by the alternating current power. More specifically, the potential wells formed by the plurality of electrode parts 112 form the slopes by the direct current power (V_{ac}[k]), such that it is possible to more easily assist in focusing the charged particles, which move in the potential wells, into the mass spectrometry device.

With reference back to FIG. 11, in some example embodiments, the k-th electrode part 112K may include a first guide portion (R_{well_in}[k]) and a second guide portion (R_{well_out}[k]). Specifically, the first guide portion (R_{well_in}[k]) refers to a region disposed adjacent to the charged particle inlet portion 1101, and the second guide portion (R_{well_out}[k]) refers to a region disposed adjacent to the charged particle outlet portion 1102.

In some example embodiments, a radius of the first guide portion (R_{well_in}[k]) may be larger than a radius of the second guide portion (R_{well_out}[k]). In this case, the above-mentioned radius may refer to a radius on the X-Y plane defined by the first direction (X-axis) and the second direction (Y-axis). Specifically, because the radius of the first guide portion (R_{well_in}[k]) is larger than the radius of the second guide portion (R_{well_out}[k]), the charged particles may be easily focused into the subsequent electrode part 112 while passing through the k-th electrode part 112K.

In some example embodiments, the charged particle beam focusing device may satisfy Equation 2 below.

$$R ( k ) = {R}_{in} \times {( {R}_{out} / {R}_{in} )}^{k / N} \qquad < Equation 2 >$$

(In Equation 2, R (k) represents a radius of the first guide portion of the k-th electrode part, Rᵢₙ represents a radius of the first guide portion of the electrode part disposed at the foremost end, Rₒᵤₜ represents a radius of the second guide portion of the electrode part disposed at the rearmost end, and N represents a value made by subtracting −1 from a total number of electrode parts.)

Equation 2 refers to a formula related to the radius of the first guide portion (R_{well_in}[k]) of the k-th electrode part 112K. Specifically, Equation 2 refers to a relationship formula with the radius of the first guide portion (R_{well_in}[k]) of the electrode part 112K. It can be ascertained from Equation 2 that the radius of the inscribed circle of the k-th electrode part 112K decreases at a desired (and/or alternatively predetermined) ratio each time k increases in accordance with the radius of the charged particle inlet portion and the radius of the charged particle outlet portion.

The charged particle beam focusing device 100 satisfies Equation 2, such that the efficiency in focusing the charged particles may be improved. In a case where the charged particle beam focusing device 100 cannot satisfy Equation 2, the charged particles cannot be easily focused, which makes it difficult for the mass spectrometry device to measure the charged particles.

In some example embodiments, the charged particle beam focusing device 100 may satisfy Equation 3 below.

$${T}_{elec} ( k ) = {T}_{elec} 0 \times {( {R}_{out} / {R}_{in} )}^{k / N} \qquad < Equation 3 >$$

(In Equation 3, T_{elec}(k) represents a thickness of the k-th electrode part, T_{elec}(0) represents a thickness of the electrode part disposed at the foremost end, Rᵢₙ represents a radius of the first guide portion of the electrode part disposed at the foremost end, Rₒᵤₜ represents a radius of the second guide portion of the electrode part disposed at the rearmost end, and N represents a value made by subtracting −1 from a total number of electrode parts.)

Equation 3 expresses the thickness of the electrode part as a function of the thickness of the electrode part disposed at the foremost end, the radius of the first guide portion disposed at the foremost end, and the radius of the second guide portion disposed at the rearmost end. In this case, the total number of electrode parts refers to the number of stages of all electrode parts including the electrode parts disposed at the foremost and rearmost ends. It can be ascertained from Equation 3 that the thicknesses of the electrode parts decrease at desired (and/or alternatively predetermined) ratios each time k increases in accordance with the radius of the charged particle inlet portion and the radius of the charged particle outlet portion.

In some example embodiments, the charged particle beam focusing device 100 may satisfy Equation 4 below.

$${T}_{gap} ( k ) = {T}_{gap} 0 \times {( {R}_{out} / {R}_{in} )}^{k / N} \qquad < Equation 4 >$$

(In Equation 4, T_{gap}(k) represents an interval between the k-th electrode part and the (k+1)th electrode part, T_{gap}(0) represents an interval between the electrode part disposed at the foremost end and the first electrode part, Rᵢₙ represents a radius of the first guide portion of the electrode part disposed at the foremost end, Rₒᵤₜ represents a radius of the second guide portion of the electrode part disposed at the rearmost end, and N represents a value made by subtracting −1 from a total number of electrode parts.)

Equation 4 expresses the interval between the electrode parts as a function of the interval between the electrode part disposed at the foremost end and the first electrode part, the radius of the first guide portion disposed at the foremost end, and the radius of the second guide portion disposed at the rearmost end. It can be ascertained from Equation 4 that the intervals between the electrode parts decrease at desired (and/or alternatively predetermined) ratios each time k increases in accordance with the radius of the charged particle inlet portion and the radius of the charged particle outlet portion.

The charged particle beam focusing device 100 satisfies Equations 3 and 4, such that the efficiency in focusing the charged particles may be improved. In a case where the charged particle beam focusing device 100 cannot satisfy Equation 4, the charged particles cannot be easily focused, which makes it difficult for the mass spectrometry device to measure the charged particles.

In some example embodiments, the charged particle beam focusing device 100 may constantly maintain ratios between the radius (R_{well_in}[k]) of the first guide portion of the k-th electrode part 112K: the radius (R_{well_out}[k]) of the second guide portion of the k-th electrode part 112K: the thickness (T_{elec}[k]) of the k-th electrode part 112K: the interval (T_{gap}[k]) between the k-th electrode part 112K and the (k+1)th electrode part. For example, it is possible to constantly maintain ratios between the radius of the first guide portion of the electrode part 112S disposed at the foremost end: the radius of the second guide portion of the electrode part 112S disposed at the foremost end: the thickness of the electrode part 112S disposed at the foremost end: the interval between the electrode part 112S disposed at the foremost end and the first electrode part 112K: the radius of the first guide portion of the first electrode part: the radius of the second guide portion of the first electrode part: the thickness of the first electrode part: the interval between the first electrode part and the second electrode part.

As described above, the charged particle beam focusing device of the present disclosure may constantly maintain the above-mentioned ratio, decrease the values of the above-mentioned factors at the same ratio in the third direction, and easily focus the charged particles under the high-vacuum pressure condition.

In some example embodiments, a ratio (T_{gap}[k]/T_{elec}[k]) of the interval (T_{gap}[k]) between the k-th electrode part and the (k+1)th electrode part to the thickness (T_{elec}[k]) of the k-th electrode part may be ⅕ or more, specifically ⅕ to 1/20, more specifically ⅛ to 1/15. However, example embodiments are not limited thereto. When the ratio satisfies the above-mentioned range, the charged particles may be easily seated on the charged particle guide portion and reduced and/or prevented from separating through the gaps between the electrode parts during the process of focusing the charged particles.

FIGS. 10 and 11 illustrate the k-th electrode part 112K, but the k-th electrode part 112K is a non-restrictive example. The same may apply to all the electrode part 112S disposed at the foremost end, the electrode part 112E disposed at the rearmost end, and the electrode part disposed between the electrode part 112S disposed at the foremost end and the electrode part 112E disposed at the rearmost end.

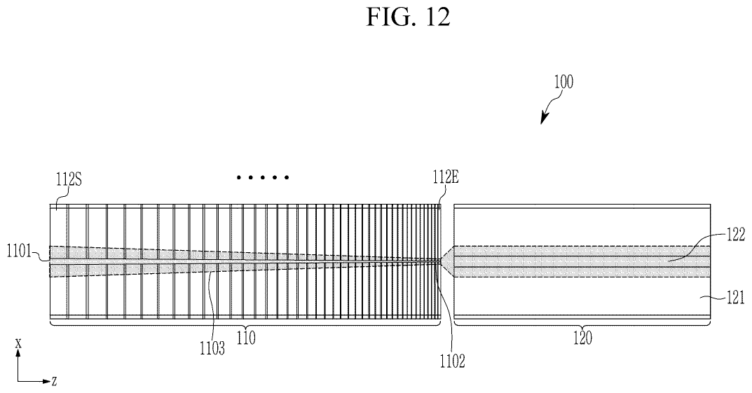

FIG. 12 is a cross-sectional view of a charged particle size sorting device including the charged particle beam focusing device 100 according to some example embodiments of the present disclosure, and FIG. 13 is a perspective view of the charged particle size sorting device including the charged particle beam focusing device 100.

With reference to FIGS. 12 and 13, the charged particle size sorting device including the charged particle beam focusing device 100 may further include a charged particle sensing part 120 configured to sort the charged particles, which have passed through the charged particle funnel 110, by size. The charged particle sensing part 120 may be a device for sorting the charged particles having a particular charge or particular mass among the charged particles focused by the charged particle funnel 110.

In some example embodiments, the charged particle sensing part 120 may include a third electrode part 121, and a charged particle output portion 122 formed by the third electrode part 121. The third electrode part 121 may have a multi-pole structure. For example, the multi-pole structure may be a structure including two or more electrodes.

In some example embodiments, it is possible to appropriately supply a (+) alternating current voltage, a (−) alternating current voltage, a (+) direct current voltage, or a (−) direct current voltage to the multi-pole structure in the third electrode part 121. When the above-mentioned voltage is supplied to the third electrode part 121, only targeted charged particles, among the charged particles focused by the charged particle funnel 110, may move along the charged particle output portion 122, such that the targeted charged particles may be sorted.

The multi-pole structure may include four cylindrical electrodes, but this is a non-restrictive example. The number of electrodes and the shape of the electrode may be variously changed under a condition in which the targeted charged particles may be sorted.

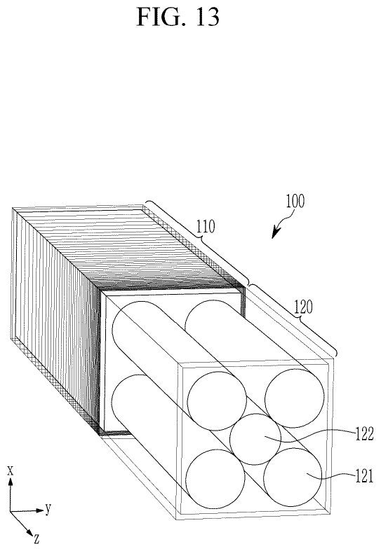

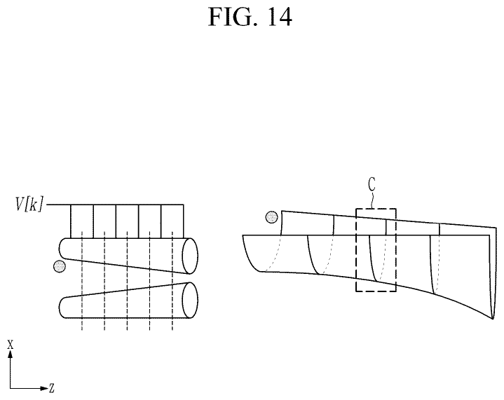

FIG. 14 is a schematic view for explaining the formation of the potential well according to some example embodiments of the present disclosure.

With reference to FIG. 14, according to some example embodiments of the present disclosure, it can be ascertained that the charged particle beam focusing device forms the potential well in accordance with the supply of power. Specifically, the left view in FIG. 14 illustrates a state in which power is supplied to the charged particle beam focusing device 100 having the plurality of inscribed circles with the radii that decrease, and the right view in FIG. 14 illustrates the potential well formed by the electrode part of the charged particle beam focusing device 100 in the left view.

More specifically, it can be ascertained that the potential well is formed as the alternating current power and/or the direct current power (V[k]) are supplied to the plurality of electrodes in the electrode parts of the charged particle beam focusing device. The charged particles may be focused while moving along the potential well.

In a case where the alternating current power is supplied to the electrode, the potential well capable of focusing the charged particles may be formed. Specifically, the (+) alternating current power and the (−) alternating current power are alternately supplied to the adjacent electrodes, such that the potential well capable of trapping and focusing the charged particles may be formed. In this case, the (+) alternating current power and the (−) alternating current power may be supplied only to the plurality of electrodes in the single electrode part as the same (+) alternating current power and the same (−) alternating current power. The magnitudes of power supplied to a plurality of electrodes in another electrode part may be different from one another.

In a case where that the direct current power is supplied to the electrode, the charged particles focused into the potential well may be guided so that the charged particles may move in the direction from the charged particle inlet portion toward the charged particle outlet portion. Specifically, because the same direct current power is supplied to the electrodes in the single electrode part, the potential well may have the slope, and the charged particles may be outputted to the mass spectrometry device by the slope.

In this case, the direct current power may be supplied only to the plurality of electrodes in the single electrode part as the same direct current power. The magnitudes of power supplied to a plurality of electrodes in another electrode part may be different from one another.

Specifically, in the charged particle beam focusing device of the present disclosure, the power supplied to the k-th electrode part may satisfy the following equation.

$$V [ k ] = \pm {V}_{AC} [ k ] + {V}_{DC} [ k ] = \pm {V}_{amp . ac} cos ( ω t ) + {V}_{DC} [ k ]$$

As described above, it can be ascertained that the k-th electrode part may form the potential well by the alternating current power (V_{AC}[k]) and form the slope of the potential well by the direct current power (V_{DC}[k]), such that the charged particles introduced into the charged particle beam focusing device may be more easily focused.

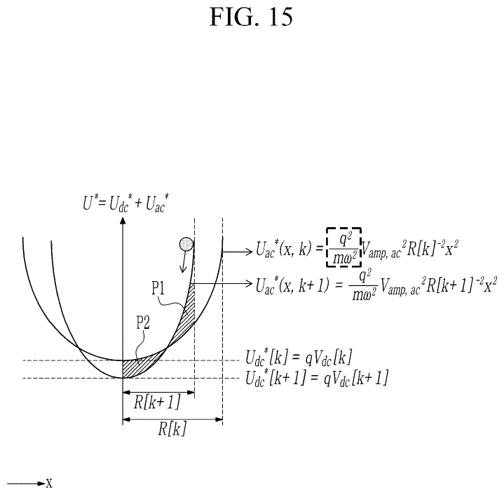

FIG. 15 is a potential well graph related to region C in FIG. 14.

FIG. 15 is a graph showing the potential wells of the k-th and (k+1)th electrode parts in the charged particle beam focusing device of the present disclosure.

With reference to FIG. 15, potential energy U′ of the entire potential well is a sum of potential energy U_{dc}* of the potential well made by the direct current power and potential energy U_{ac}* of the potential well made by the alternating current power. As described above, it may be possible to improve the efficiency in focusing the charged particles by controlling the shape of the potential well in the charged particle beam focusing device by changing the condition of the direct current power and the alternating current power.

In some example embodiments, in the charged particle beam focusing device, a frequency (ω) of the (+) alternating current power or the (−) alternating current power may be variably supplied to the plurality of electrode parts. Specifically, in the charged particle beam focusing device, the potential energy made by the alternating current power satisfies Equation 5. Equation 5 below may refer to a potential energy value in accordance with alternating current power in a general quadrupole charged particle beam focusing device.

$${U}_{ac}^{*} ( x , k ) = {q}^{2} / m {ω}^{2} {V}_{amp , {ac}^{2}} R {( k )}^{- 2} {x}^{2} \qquad < Equation 5 >$$

(U*_{ac}(x, k) represents potential energy of the potential well made by the alternating current power of the k-th electrode part, q represents a charge quantity of the charged particles, m represents a mass of the charged particle, w represents a frequency of the alternating current power, V_{amp.ac} represents an alternating current power amplitude of the k-th electrode part, and R(k) represents a radius of the inscribed circle in the k-th electrode part.)

In some example embodiments, the frequency of the alternating current power may be variably controlled so that q²/(mω²) is constantly maintained in accordance with a charge quantity (q) of the charged particles and a mass (m) of the charged particles in Equation 5. Specifically, in Equation 5, when the charge quantity (q) and the mass (m) of the charged particles inputted to the charged particle beam focusing device are changed, the frequency (w) of the alternating current power is changed on the basis of the change in the charge quantity (q) and the mass (m), such that a value of q²/(mω²) is controlled to be the same value under various conditions related to the charged particle charge quantity (q) and the mass (m). Therefore, it is possible to achieve the same (or similar) focusing passage for improving efficiency for the charged particles having various charge quantities masses.

In some example embodiments, in the potential well of each of the adjacent electrode parts among the electrode parts, a direct current power difference (V_{dc}[k+1]−V_{dc}[k]) may be supplied to one or more points at which an area value between a first region P1 at the right side and a second region P2 at the left side is constant based on an intersection point. Specifically, the potential wells of the k-th electrode part and the (k+1)th electrode part in FIG. 15 will be described. The potential well of the (k+1)th electrode part may have a shape convexly formed below the potential well of the k-th electrode part by the direct current power.

As described above, the graph of the potential well of the (k+1)th electrode part forms the slope below the potential well of the k-th electrode part. The direct current power may need to be supplied to one or more points at which the area values of the first region P1 and the second region P2 formed at the right and left sides based on an intersection point of the potential well graphs of the k-th electrode part and the (k+1)th electrode part, so that the charged particles move to the potential well of the (k+1)th electrode part without moving from the potential well of the k-th electrode part to the potential well of the k-first electrode part.

As described above, because variable power is supplied to the electrode part including the electrode, specifically, power, which satisfies the alternating current power value and the direct current power value, is supplied to the plurality of electrode parts, the charged particle beam focusing device may improve the efficiency in focusing the charged particles in a high vacuum.

According to some example embodiments of the present disclosure, the charged particles passing through the charged particle beam focusing device are in a three-dimensional space (x, y, z). However, with reference to FIGS. 14 and 15, the analysis is performed in a two-dimensional space (x, z) for convenience.

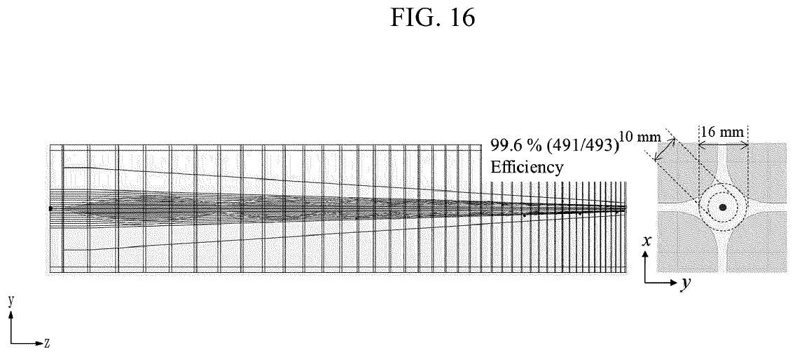

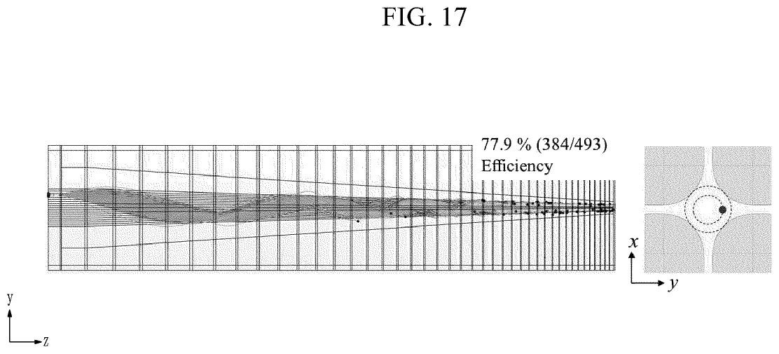

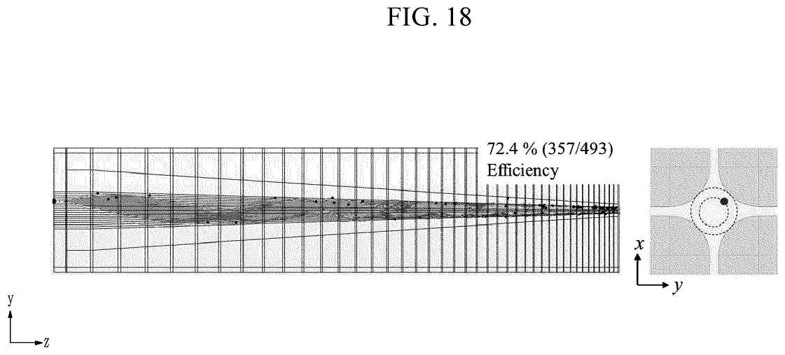

FIGS. 16 to 18 are graphs showing results of evaluating a charged particle focusing output of the charged particle beam focusing device of the present disclosure.

FIGS. 16 to 18 illustrate result values related to trajectories of the charged particles when the charged particle beam focusing device operates in accordance with three initial positions of the charged particles. In this case, the three initial positions were respectively positioned at a center and two positions on an edge in a region with a radius of 5 mm. The condition of the charged particles is 493 −1 single-charged nanoparticles that perform free motions in a Maxwellian velocity distribution and have a diameter of 5.5 nm, and vₚₘₐₓ=7.57 m/s, v_{z}≥0. In addition, the frequency of the AC power was maintained to be 125 kHz, and the evaluation was performed at a temperature of 20° C. under a complete vacuum pressure condition.

Table 1 below shows values representing structural and electrical parameters of the charged particle beam focusing device.

The charged particle beam focusing device of Table 1 below used the electrode part (k=0) disposed at the foremost end, the electrode part (k=41) disposed at the rearmost end, and 42 stages (N+1 stages) including electrode parts from k=1 to k=41 with respect to the number of electrode parts in the charged particle funnel. As described above, in a case where the number of electrode parts or the number of stages is 42, the electrode part (k=0) at the foremost end, the first electrode part (k=1), the second electrode part (k=2), . . . , the 40th electrode part (k=40), and the electrode part (N=k+1=41) at the rearmost end are satisfied, and the total number of electrode parts is N+1, e.g., 42 stages.

In addition, a length in a horizontal direction, e.g., the third direction (Z-axis) of the charged particle funnel was 200 mm, a radius of the inscribed circle of the charged particle inlet portion was 8 mm, and a radius of the inscribed circle of the charged particle outlet portion was 1.25 mm.

In addition, the AC power amplitude was fixed to 100 V, 150 kHz or less was used as the AC power frequency, and fixed DC power of 10 V or less was applied to the electrode parts.

In addition, the AC frequency (ω) value was changed to maintain the constant q²/mω² factor in accordance with the mass (m) and the charge quantity (q) of the target charged particles.

TABLE 1

| | Structural parameter [mm] | | | | Electrical parameter [V] | |
|---|---|---|---|---|---|---|
| k | T_{elec}[k] | T_{gap}[k] | R_{well}_{_{—}}ᵢₙ[k] | R_{well}_{_{—}}ₒᵤₜ[k] | V_{ac, amp}[k] | V_{dc}[k] |
| 0 | 9 | 1 | 8 | 8 | 100 | 0.00 |
| 1 | 9.67 | 1.08 | 8 | 7.64 | 100 | 0.00 |
| 2 | 9.24 | 1.02 | 7.64 | 7.29 | 100 | 0.04 |
| 3 | 8.82 | 0.98 | 7.29 | 6.96 | 100 | 0.04 |
| 4 | 8.42 | 0.93 | 6.96 | 6.64 | 100 | 0.08 |
| 5 | 8.04 | 0.89 | 6.64 | 6.34 | 100 | 0.09 |
| 6 | 7.67 | 0.85 | 6.34 | 6.06 | 100 | 0.13 |
| 7 | 7.32 | 0.82 | 6.06 | 5.78 | 100 | 0.15 |
| 8 | 6.99 | 0.78 | 5.78 | 5.52 | 100 | 0.20 |
| 9 | 6.67 | 0.75 | 5.52 | 5.27 | 100 | 0.21 |
| 10 | 6.37 | 0.71 | 5.27 | 5.03 | 100 | 0.27 |
| 11 | 6.08 | 0.68 | 5.03 | 4.8 | 100 | 0.30 |
| 12 | 5.81 | 0.64 | 4.8 | 4.58 | 100 | 0.37 |
| 13 | 5.54 | 0.62 | 4.58 | 4.38 | 100 | 0.40 |
| 14 | 5.29 | 0.59 | 4.38 | 4.18 | 100 | 0.47 |
| 15 | 5.05 | 0.56 | 4.18 | 3.99 | 100 | 0.52 |
| 16 | 4.82 | 0.54 | 3.99 | 3.81 | 100 | 0.61 |
| 17 | 4.6 | 0.52 | 3.81 | 3.63 | 100 | 0.67 |
| 18 | 4.4 | 0.48 | 3.63 | 3.47 | 100 | 0.77 |
| 19 | 4.2 | 0.46 | 3.47 | 3.31 | 100 | 0.84 |
| 20 | 4.01 | 0.44 | 3.31 | 3.16 | 100 | 0.97 |
| 21 | 3.82 | 0.43 | 3.16 | 3.02 | 100 | 1.05 |
| 22 | 3.65 | 0.41 | 3.02 | 2.88 | 100 | 1.20 |
| 23 | 3.49 | 0.38 | 2.88 | 2.75 | 100 | 1.31 |
| 24 | 3.33 | 0.37 | 2.75 | 2.63 | 100 | 1.48 |
| 25 | 3.18 | 0.35 | 2.63 | 2.51 | 100 | 1.61 |
| 26 | 3.03 | 0.34 | 2.51 | 2.39 | 100 | 1.82 |
| 27 | 2.89 | 0.33 | 2.39 | 2.29 | 100 | 2.00 |
| 28 | 2.76 | 0.31 | 2.29 | 2.18 | 100 | 2.19 |
| 29 | 2.64 | 0.29 | 2.18 | 2.08 | 100 | 2.47 |
| 30 | 2.52 | 0.28 | 2.08 | 1.99 | 100 | 2.68 |
| 31 | 2.4 | 0.27 | 1.99 | 1.9 | 100 | 2.98 |
| 32 | 2.3 | 0.25 | 1.9 | 1.81 | 100 | 3.27 |
| 33 | 2.19 | 0.24 | 1.81 | 1.73 | 100 | 3.66 |
| 34 | 2.09 | 0.23 | 1.73 | 1.65 | 100 | 3.96 |
| 35 | 2 | 0.22 | 1.65 | 1.58 | 100 | 4.45 |
| 36 | 1.91 | 0.21 | 1.58 | 1.5 | 100 | 4.76 |
| 37 | 1.82 | 0.2 | 1.5 | 1.44 | 100 | 5.50 |
| 38 | 1.74 | 0.19 | 1.44 | 1.37 | 100 | 5.66 |
| 39 | 1.66 | 0.18 | 1.37 | 1.31 | 100 | 6.71 |
| 40 | 1.58 | 0.17 | 1.31 | 1.25 | 100 | 6.86 |
| 41 | 1.5 | 0 | 1.25 | 1.25 | 100 | 8.08 |

With reference to FIGS. 16 to 18, it can be ascertained that the efficiency in focusing the charged particles is as good at 70% or more in a case where the charged particles are present at the initial position in a region with an input side radius of 5 mm. Specifically, it can be ascertained that in a case where the charged particles are disposed in the central portion of the input region, the efficiency in focusing the charged particles is as excellent at 99% or more. As described above, with reference to FIGS. 16 to 18, it may be possible to identify the efficiency in focusing the charged particle in accordance with the initial position of the charged particles.

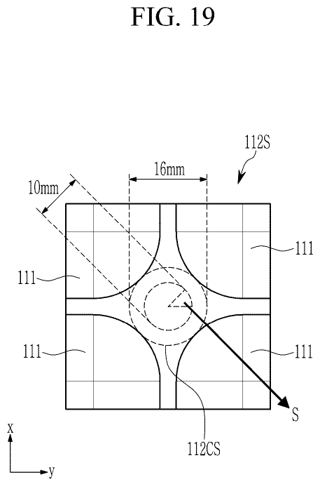

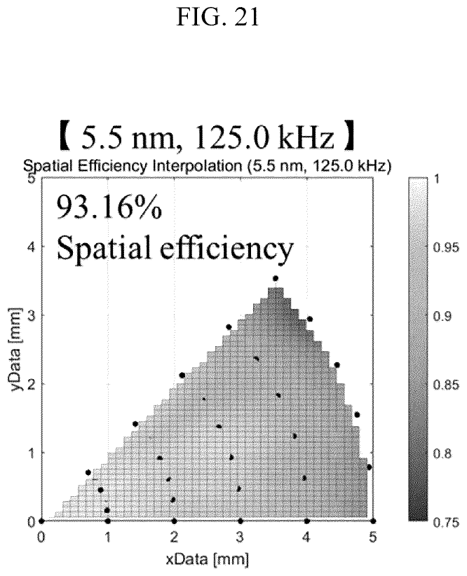

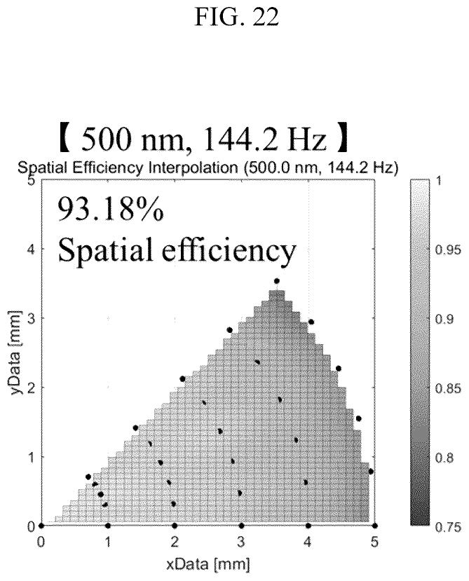

FIGS. 19 to 22 are views illustrating results of evaluating spatial efficiency of the charged particle beam focusing device of the present disclosure.

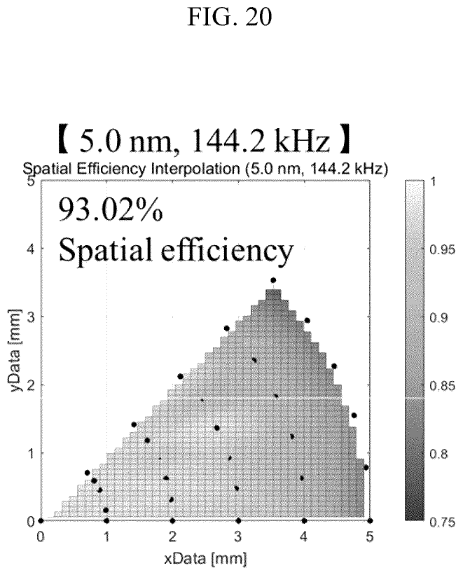

FIGS. 19 to 22 illustrate output spatial efficiency of the charged particle beam focusing device to the input of the charged particles in an input region with a diameter of 10 mm. In this case, in order to identify the output spatial efficiency to the input region, passage efficiency interpolation result values are shown in accordance with the initial positions of the 31 charged particle in region S in FIG. 19 in consideration of the structure and electrical symmetry of the charged particle beam focusing device. Region S refers to a region of ⅛ of an input region with a diameter of 10 mm, and the diameters of the charged particles were 5 nm, 5.5 nm, and 500 nm in FIGS. 20 to 22. The charge amount of the charged particles was −1 under three types of charged particle diameter conditions.

Table 2 below shows a target charged particle diameter (d_{target}) and an AC power frequency (f_{ac}).

TABLE 2

| | |
|---|---|
| Target charged particle diameter | AC power frequency |
| d_{target} | f_{ac} |

| | | | |
|---|---|---|---|
| 5 | nm | 144.2 | kHz |
| 5.5 | nm | 125.0 | kHz |
| 10 | nm | 51.0 | kHz |
| 20 | nm | 18.0 | kHz |
| 50 | nm | 4.56 | kHz |
| 100 | nm | 1.61 | kHz |
| 200 | nm | 570 | Hz |
| 500 | nm | 144.2 | Hz |

With reference to Table 2 and FIGS. 19 to 22, it can be ascertained that the frequency of the AC power, e.g., alternating current power is variably applied by the above-mentioned q²/mω² factor in accordance with the diameters of the target charged particles. It can be ascertained that the frequency is controlled in accordance with the target charged particle diameter, the same spatial efficiency of 93% or more is implemented for each of the target charged particle diameters.

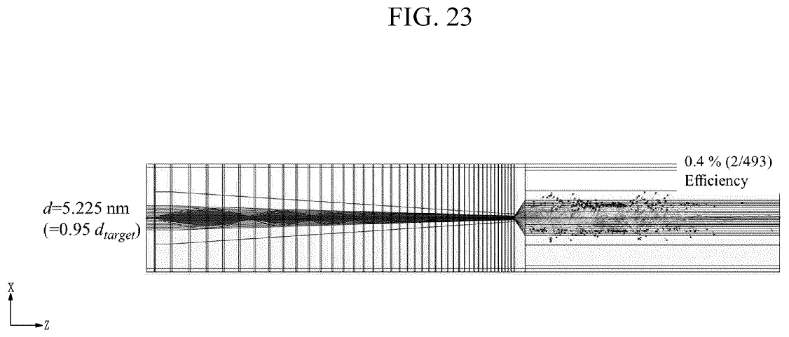

FIGS. 23 to 25 are graphs showing results of evaluating charged particle passage efficiency of the charged particle size sorting device including the charged particle beam focusing device in FIGS. 12 and 13.

FIGS. 23 to 25 illustrate the charged particle passage efficiency of the charged particle size sorting device including the charged particle beam focusing device, as illustrated in FIGS. 12 and 13. In this case, the condition related to the charged particle funnel was set in the same way as illustrated in FIGS. 16 to 22. The charged particle sensing part used a quadrupole, a radius of the quadrupole was 12.2 mm, and a radius of an inscribed circle formed by the quadrupole was 10.5 mm. In addition, a length of the charged particle sensing part in the horizontal direction was 150 mm.

In addition, as electrical components of the charged particle sensing part, the alternating current power was 90.25 V, the direct current power was 14.5 V, and the frequency was 0.08 times the alternating current power frequency of the charged particle funnel.

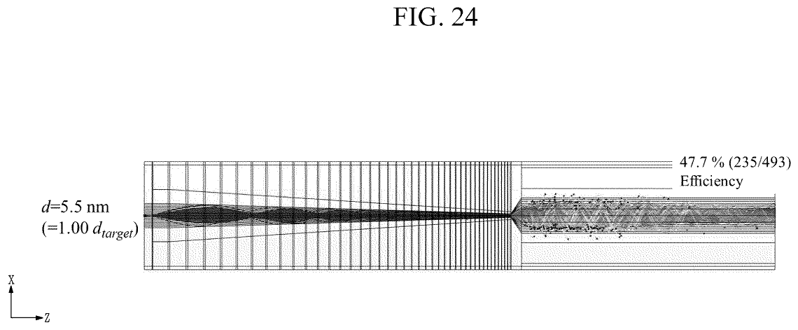

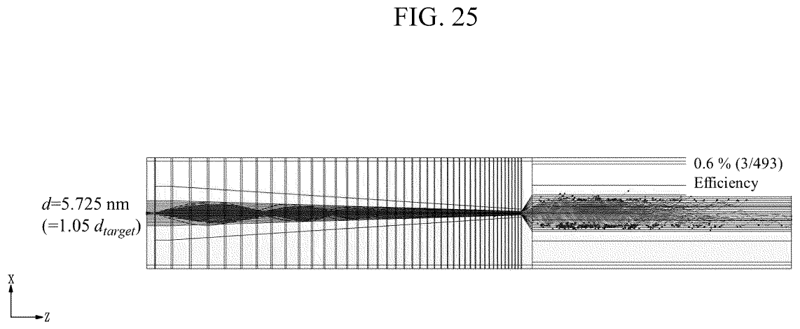

With reference back to FIGS. 23 to 25, the trajectory of the charged particle has been described in a case where the diameter of the input charged particle has an error of ±5% in comparison with the target charged particle diameter in the state in which the direct current and alternating current power parameters are fixed to suit the target charged particles. In this case, the sorting efficiency was identified by supplying 493 charged particles at the initial position of the center of the input region when the target charged particle was the −1 single charged particle, e.g., a NaCl particle with a diameter of 5.5 nm. With reference to FIGS. 23 and 25, it can be ascertained that only the input charged particles of 0.6% or less pass in a case where the diameter of the input charged particle has an error of +5% in comparison with the target charged particle diameter. It can be ascertained that the input charged particles pass at a ratio of about 47.7% and are sensed in FIG. 24 in which the diameter of the input charged particle is equal to or substantially equal to the target charged particle diameter.

As described above, as can be seen from FIGS. 23 to 25, it can be ascertained that the charged particle sensing part is included, such that only the charged particles, which have target diameters among the inputted charged particles, may be separately sensed.

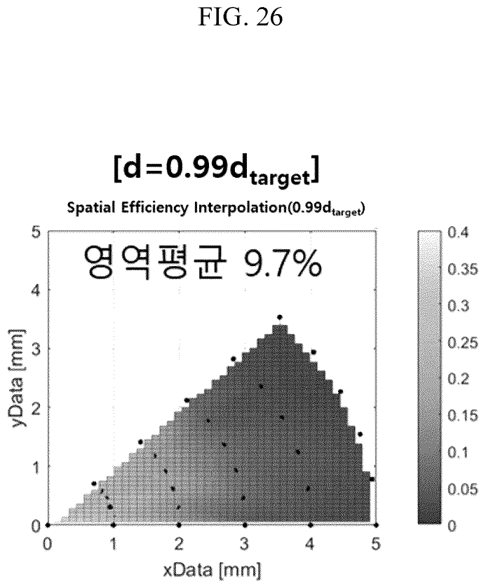

FIGS. 26 to 30 are views illustrating results of evaluating spatial efficiency of the charged particle size sorting device including the charged particle beam focusing device in FIGS. 12 and 13.

FIGS. 26 to 30 illustrate values of results of identifying, on the basis of the spatial efficiency, the sorting resolution of the charged particle size sorting device including the charged particle beam focusing device in FIGS. 12 and 13. Specifically, the value of the result of identifying particle diameter measurement resolution of the charged particle size sorting device including the charged particle beam focusing device is provided on the basis of the spatial efficiency. In this case, in consideration of the structure and electrical symmetry of the charged particle beam focusing device and the charged particle size sorting device, the calculation of the spatial efficiency utilized the passage efficiency interpolation according to 31 initial positions in a region of ⅛ of the input region with a diameter of 10 mm.

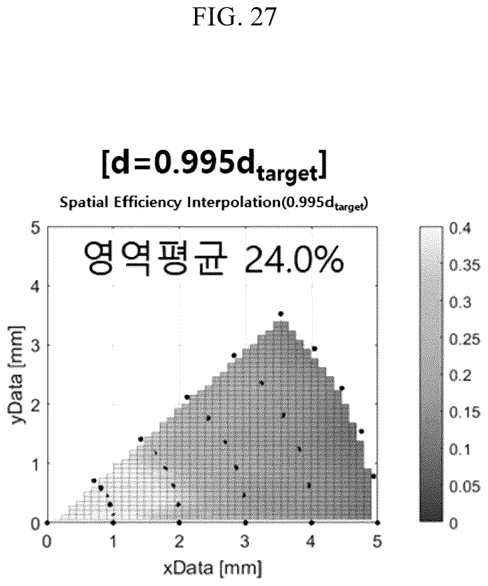

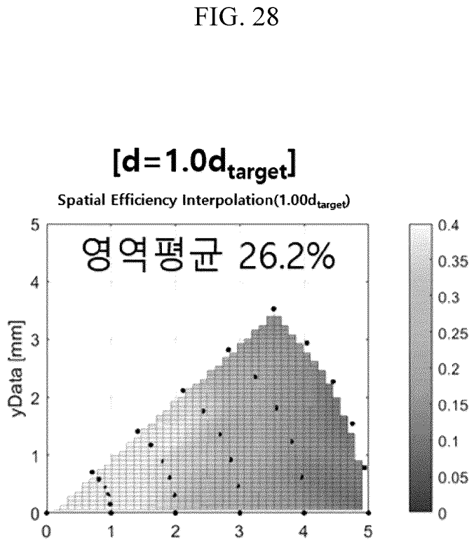

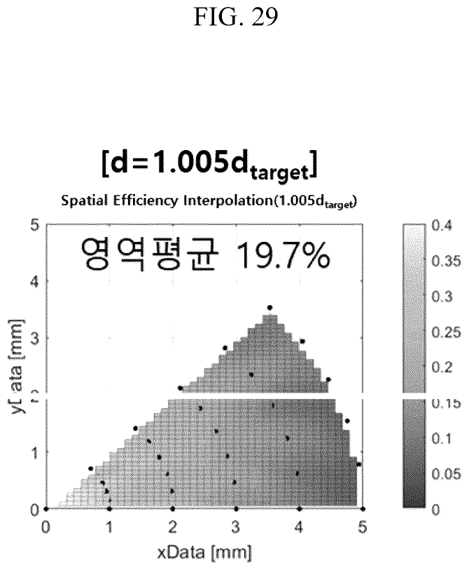

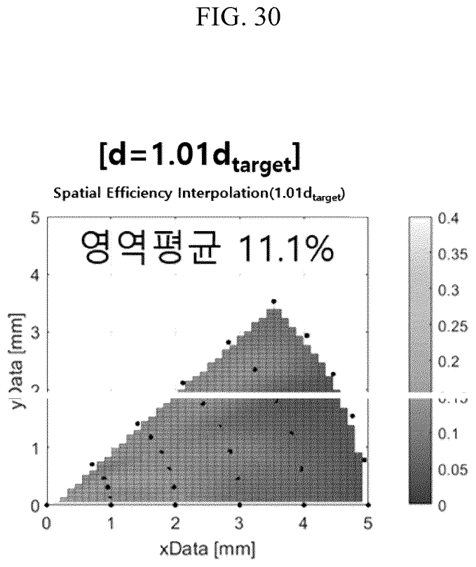

With reference back to FIGS. 26 to 30, it was ascertained that when the input charged particle diameter was a particle diameter equal to or substantially equal to the target charged particle diameter, the passage efficiency was as good at 25% or more, as illustrated in FIG. 28. It was ascertained that in FIGS. 27 and 29 in which the input charged particle diameter had an error of 0.5% in comparison with the target charged particle diameter and FIGS. 26 and 30 in which an error was 1%, the passage efficiency deteriorated. Numerically, the particle diameter measurement resolution of ±0.9% of a full-width half maximum (FWHM) was ascertained.

The present disclosure is not limited to the implementations and/or example embodiments disclosed above but may be implemented in various different forms, and those skilled in the art will understand that example embodiments of the present disclosure may be implemented in any other specific form without changing the technical spirit or the essential feature of the present disclosure. Therefore, it should be understood that the above-described implementations and/or example embodiments are illustrative in all aspects and do not limit the present disclosure.

What is claimed is:

1. A charged particle beam focusing device comprising:
a charged particle funnel configured to move charged particles,
wherein the charged particle funnel comprises
an electrode part including a plurality of electrode parts stacked in a first direction,
a charged particle inlet portion in an electrode part at a foremost end among the plurality of electrode parts, the charged particle inlet portion configured to introduce the charged particles,
a charged particle outlet portion in an electrode part at a rearmost end among the plurality of electrode parts the charged particle outlet portion configured to discharge the charged particles, and
a charged particle guide portion extending from the charged particle inlet portion to the charged particle outlet portion and configured to move the charged particles,
the plurality of electrode parts each comprises a plurality of electrodes arranged on a plane in a second direction, the second direction being perpendicular to the first direction,
the charged particle guide portion is a region in which inscribed circles between each of the plurality of electrodes on the plane extend from the charged particle inlet portion to the charged particle outlet portion, and
a radii of each of the inscribed circles decreases from the charged particle inlet portion toward the charged particle outlet portion.

2. The charged particle beam focusing device of claim 1, wherein
a thickness of each electrode parts of the plurality of electrode parts of the charged particle funnel decreases in the first direction.

3. The charged particle beam focusing device of claim 1, wherein
each electrode part of the plurality of electrode parts is spaced apart from one another at an interval, and
the interval between each pair of electrode parts of the plurality of electrode parts decreases in the first direction.

4. The charged particle beam focusing device of claim 1, wherein
the plurality of electrode parts includes five or more electrode parts adjacent to one another, and
the plurality of electrode parts are arranged in the first direction.

5. The charged particle beam focusing device of claim 1, wherein
each electrode of the plurality of electrodes has a multi-pole structure and is spaced apart from one another.

6. The charged particle beam focusing device of claim 1, wherein
a shape of each electrode of the plurality of electrodes is convex toward a direction of a central portion of each of the plurality of electrode parts, respectively.

7. The charged particle beam focusing device of claim 1, wherein
each electrode part comprises at least two or more electrodes, and
each of the electrode parts comprises an even number of electrodes.

8. The charged particle beam focusing device of claim 1, wherein
an alternating current (AC) power is supplied to the plurality of electrodes,
the alternating current (AC) power includes a (+) alternating current power and a (−) alternating current power equal to each other, and
the (+) alternating current power and the (−) alternating current power are alternately supplied to each pair of electrodes of the plurality of electrodes adjacent to one another.

9. The charged particle beam focusing device of claim 1, wherein
a direct current (DC) power is supplied to the plurality of electrodes.

10. The charged particle beam focusing device of claim 1, wherein
the electrode part comprises
a first guide portion adjacent to the charged particle inlet portion, and
a second guide portion adjacent to the charged particle outlet portion, and
a radius of the first guide portion is larger than a radius of the second guide portion.

11. The charged particle beam focusing device of claim 10, wherein
the radius decreases from the first guide portion toward the second guide portion.

12. The charged particle beam focusing device of claim 10, wherein
the radius of the first guide portion decreases in the first direction with respect to the plurality of electrode parts.

13. The charged particle beam focusing device of claim 1, wherein Expression 1 below is satisfied,
$$3 \leq {R}_{out} / {R}_{in} \leq 15 \qquad < Expression 1 >$$
(in Expression 1, Rᵢₙ represents a radius of a first guide portion of the electrode part at the foremost end among the plurality of electrode parts, and Rₒᵤₜ represents a radius of a second guide portion of the electrode part at the rearmost end among the plurality of electrode parts).

14. The charged particle beam focusing device of claim 1, wherein Equation 2 below is satisfied,
$$R ( k ) = {R}_{in} \times {( {R}_{out} / {R}_{in} )}^{k / N} \qquad < Equation 2 >$$
(in Equation 2, R(k) represents a radius of a first guide portion of a k-th electrode part, Rᵢₙ represents a radius of the first guide portion of the electrode part at the foremost end, Rₒᵤₜ represents a radius of a second guide portion of the electrode part at the rearmost end, and N represents a value made by subtracting −1 from a total number of electrode parts).

15. The charged particle beam focusing device of claim 1, wherein Equation 3 below is satisfied,
$${T}_{elec} ( k ) = {T}_{elec} 0 \times {( {R}_{out} / {R}_{in} )}^{k / N} \qquad < Equation 3 >$$
(in Equation 3, T_{elec}(k) represents a thickness of a k-th electrode part, T_{elec}(0) represents a thickness of the electrode part at the foremost end, Rᵢₙ represents a radius of a first guide portion of the electrode part at the foremost end, Rₒᵤₜ represents a radius of a second guide portion of the electrode part at the rearmost end, and N represents a value made by subtracting −1 from a total number of electrode parts).

16. The charged particle beam focusing device of claim 1, wherein Equation 4 below is satisfied,
$${T}_{gap} ( k ) = {T}_{gap} 0 \times {( {R}_{out} / {R}_{in} )}^{k / N} \qquad < Equation 4 >$$
(in Equation 4, T_{gap}(k) represents an interval between a k-th electrode part and a (k+1)th electrode part, T_{gap}(0) represents an interval between the electrode part at the foremost end and an adjacent electrode part, Rᵢₙ represents a radius of a first guide portion of the electrode part at the foremost end, Rₒᵤₜ represents a radius of a second guide portion of the electrode part at the rearmost end, and N represents a value made by subtracting −1 from a total number of electrode parts).

17. A charged particle beam focusing device comprising:
a charged particle funnel configured to move charged particles,
wherein the charged particle funnel comprises
an electrode part including a plurality of electrode parts stacked in a first direction,
the plurality of electrode parts each comprises a plurality of electrodes arranged on a plane in a second direction, the second direction being perpendicular to the first direction,
an alternating current power includes a (+) alternating current (AC) power or a (−) alternating current power alternately supplied to each pair of electrodes of the plurality of electrodes adjacent to one another, and
wherein the alternating current power is variably supplied to the plurality of electrode parts.

18. The charged particle beam focusing device of claim 17, wherein:
a frequency (ω) of the (+) alternating current power or the (−) alternating current power is variably supplied to the plurality of electrode parts, and
the frequency is variably controlled so that q²/(mω²) is constantly maintained in accordance with a charge quantity (q) of the charged particles and a mass (m) of the charged particles in Equation 5 below,
$${U}_{ac}^{*} ( x , k ) = {q}^{2} / m {ω}^{2} {V}_{amp , {ac}^{2}} R {( k )}^{- 2} {x}^{2} \qquad < Equation 5 >$$
(U*_{ac}(x, k) represents potential energy of a potential well made by the alternating current power of a k-th electrode part, q represents a charge quantity of the charged particles, m represents a mass of a charged particle, ω represents a frequency of the alternating current power, V_{amp.ac} represents an alternating current power amplitude of the k-th electrode part, and R(k) represents a radius of an inscribed circle in the k-th electrode part).

19. The charged particle beam focusing device of claim 17, wherein
direct current (DC) power is supplied to the electrode part, and
in a potential well of each adjacent electrode parts among the plurality of electrode parts, direct current power is supplied to one or more points to an area value between a first region at a right side and a second region at a left side is constant based on an intersection point.

20. A charged particle beam focusing device comprising:
a charged particle funnel configured to move charged particles,
wherein the charged particle funnel comprises
an electrode part including a plurality of electrode parts stacked in a first direction and configured to be supplied with a variable power;
a charged particle inlet portion in an electrode part at a foremost end among the plurality of electrode parts, and the charged particle inlet portion configured to introduce the charged particles;
a charged particle outlet portion in an electrode part at a rearmost end among the plurality of electrode parts, the charged particle outlet portion configured to discharge the charged particles; and
a charged particle guide portion extending from the charged particle inlet portion to the charged particle outlet portion and configured to move the charged particles,
the plurality of electrode parts each comprises a plurality of electrodes arranged on a plane in a second direction, the second direction being perpendicular to the first direction,
wherein the charged particle guide portion is a region including inscribed circles between each of the plurality of electrodes on the plane extend from the charged particle inlet portion to the charged particle outlet portion, and
a radii of each of the inscribed circles, thicknesses of the plurality of electrode parts, and intervals between the plurality of electrode parts decrease in one direction.
